(19) United States
(12) Patent Application Publication
(10) Pub. No.: US 2021/0362608 A1
(43) Pub. Date: Nov. 25, 2021

(54) VEHICLE DRIVE DEVICE

(71) Applicant: AISIN CORPORATION, Kariya-shi, Aichi (JP)

(72) Inventors: Akiya KUME, Anjo-shi (JP); Yasuyuki SATO, Anjo-shi (JP); Wataru YAMADA, Kariya-shi (JP)

(73) Assignee: AISIN CORPORATION, Kariya-shi, Aichi (JP)

(21) Appl. No.: 17/286,240

(22) PCT Filed: Sep. 5, 2019
(86) PCT No.: PCT/JP2019/034958

§ 371 Date: Apr. 16, 2021

(30) Foreign Application Priority Data
Oct. 17, 2018 (JP) 2018-196097

(51) Int. Cl. B60L 50/16; B60L 58/24; B60L 3/00; B60L 50/51; H02P 29/62

(52) U.S. Cl. CPC B60L 50/16; B60L 58/24; B60L 3/003; B60L 3/0061; B60L 2240/36; B60L 50/51; H02P 29/62; B60L 2240/425; B60L 3/0046

(57) ABSTRACT

A power storage device is appropriately heated in a low temperature environment, while preventing device configuration from becoming complicated, and minimizing a reduction in electric power utilization efficiency. A vehicle drive device includes a rotary electric machine that includes plurality of mutually independent coil sets each including coils of plurality of phases connected to each other, plurality of inverters that independently control respective plurality of coil sets, a power storage device, heat transfer system that transfers heat to power storage device, and control device that controls plurality of inverters. The control device performs warm-up control by performing power running control on at least one of inverters and performing regenerative control on at least another of inverters in such a manner that power running torque resulting from power running control and regenerative torque resulting from regenerative control have different absolute values so that a rotor of rotary electric machine rotates.

### TECHNICAL FIELD

The present disclosure relates to a vehicle drive device including a rotary electric machine that includes a plurality of mutually independent coil sets, each including coils of a plurality of phases connected to each other, and that serves as a drive power source for a vehicle.

### BACKGROUND ART

Electric vehicles (EVs) equipped with a rotary electric machine as a vehicle drive source and hybrid vehicles (HEVs) equipped with a rotary electric machine and an internal combustion engine have been put into practical use. Japanese Unexamined Patent Application Publication No. 2000-41392 discloses a vehicle drive device including a rotary electric machine that includes a plurality of mutually independent coil sets, each including coils of a plurality of phases connected to each other, and serves as a drive power source for a vehicle. In this type of vehicle drive device, different inverters are connected to different coil sets. Accordingly, with respect to the current flowing to the rotary electric machine, the amount of current that flows through each inverter can be reduced to about a half. Therefore, even when causing the rotary electric machine to output a high torque, the loss in the inverters can be reduced. Moreover, even if one of the inverters fails, the rotary electric machine can be driven by another inverter.

A rotary electric machine for driving a vehicle is rotated with electric power supplied from a power storage device such as a secondary battery mounted on the vehicle. Meanwhile, electric power generated by the rotary electric machine rotated with mechanical power transmitted to a rotor is supplied to the power storage device to charge the power storage device. The performance of the power storage device is dependent on the temperature. The current that can be output from the power storage device tends to be low, especially at low temperature compared to those at normal temperature and high temperature. As a result, it is often difficult to cause the rotary electric machine to output a required torque.

Japanese Unexamined Patent Application Publication No. 2018-88766 (JP 2018-88766 A) discloses a vehicle (1) including a heater (31) for heating a power storage device when the temperature is low (the reference numerals in parenthesis in BACKGROUND ART are those used in JP 2018-88766 A). The vehicle (1) includes a main battery (10) serving as a power storage device connected to a rotary electric machine, and a sub battery (20) with a voltage (for example, 12 [V]) lower than a voltage (for example, 350 [V]) of the main battery (10). The heater (31) for heating the main battery (10) is connected to the sub battery (20) via a switch (SW1). When the temperature of the main battery (10) is less than a threshold (Tth1), the switch (SW1) is controlled to be on, so that the main battery (10) is heated by the heater (31).

### RELATED ART DOCUMENTS

### Patent Documents

Patent Document 1: Japanese Unexamined Patent Application Publication No. 2000-41392
Patent Document 2: Japanese Unexamined Patent Application Publication No. 2018-88766

### SUMMARY OF THE DISCLOSURE

### Problem to be Solved by the Disclosure

As described above, since the power storage device is heated by the heater, a reduction in performance of the power storage device due to the temperature is minimized, thereby making the rotary electric machine operate appropriately. However, with this configuration, it is necessary to separately provide a heater for heating the power storage device, resulting in a complicated device structure and hence an increase in costs. Moreover, since electric power is consumed by the heater, the utilization efficiency of electric power in the entire vehicle is reduced. This presents a problem in terms of energy saving of the vehicle. That is, there is a problem in appropriately heating a power storage device in a vehicle drive device including a rotary electric machine that includes a plurality of mutually independent coil sets, each including coils of a plurality of phases connected to each other, and serves as a drive power source for a vehicle.

In view of the above, it is desired to provide a technique that appropriately heats a power storage device in a low temperature environment, while preventing the device structure from becoming complicated, and minimizing a reduction in electric power utilization efficiency.

### Means for Solving the Problem

In view of the above, according to one aspect, there is provided a vehicle drive device including: a rotary electric machine that includes a plurality of mutually independent coil sets, each including coils of a plurality of phases connected to each other, and that serves as a drive power source for a vehicle; a plurality of inverters that independently control currents flowing through the respective plurality of coil sets; at least one power storage device connected to the plurality of inverters; a heat transfer system that transfers heat between the power storage device and at least one of the rotary electric machine and the plurality of inverters; and a control device that controls the plurality of inverters to control the rotary electric machine; wherein the control device performs warm-up control by performing power running control on at least one of the plurality of inverters and performing regenerative control on at least another of the inverters in such a manner that a power running torque resulting from the power running control and a regenerative torque resulting from the regenerative control have different absolute values so that a rotor of the rotary electric machine rotates.

According to this configuration, with the warm-up control, a current is applied to the coil set of the rotary electric machine via the inverter to cause the rotary electric machine and the inverter to generate heat. The generated heat is transferred to the power storage device via a heat transfer system, thereby heating the power storage device. Therefore, there is no need to separately provide a heater or other devices for heating the power storage device, thereby preventing the device structure from becoming complicated. Meanwhile, at least one of the coil sets of the rotary electric machine is subjected to the power running control, and at least one of the other coil sets is subjected to the regenerative control, while the warm-up control is performed. Accordingly, the electric power consumed by the power running control, excluding the electric power consumed by heat generation of the coils, can be collected by the regenerative control. This makes it possible to reduce the electric power of the power storage device consumed for heating the power storage device. Thus, with this configuration, it is possible to appropriately heat the power storage device in a low temperature environment, while preventing the device configuration from becoming complicated, and minimizing a reduction in electric power utilization efficiency.

Other features and advantages of the vehicle drive device will become apparent from the following description of the embodiments with reference to the accompanying drawings.

### BRIEF DESCRIPTION OF THE DRAWINGS

FIG. 1 is a schematic diagram illustrating an electric system block that controls driving of a rotary electric machine.

FIG. 2 is a schematic diagram illustrating an example of a power transmission path and a control system thereof.

FIG. 3 is a schematic diagram illustrating an exemplary configuration of a heat transfer system.

FIG. 4 is a flowchart illustrating an example of warm-up control.

FIG. 5 illustrates the relationship between the temperature of a power storage device and each of a power running torque and a regenerative torque.

### MODES FOR CARRYING OUT THE DISCLOSURE

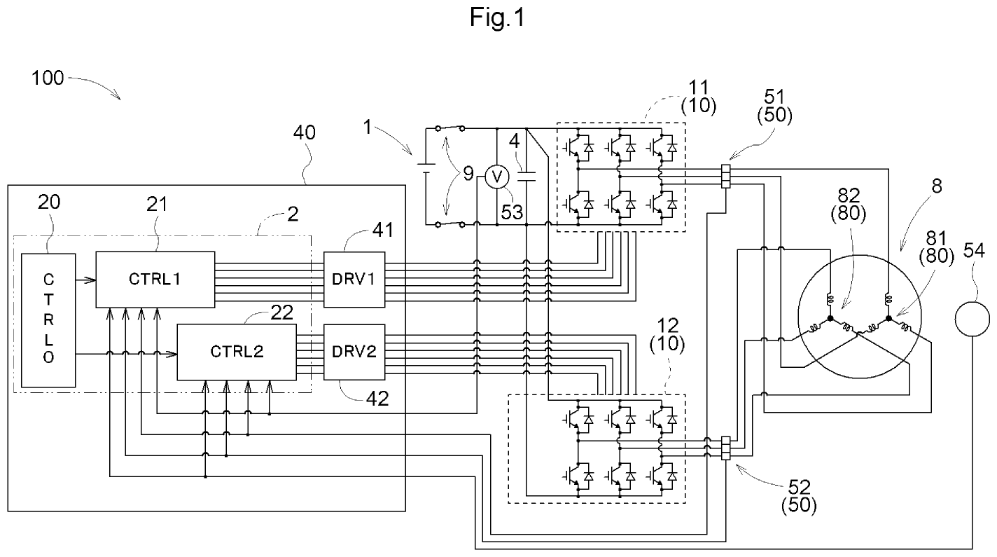

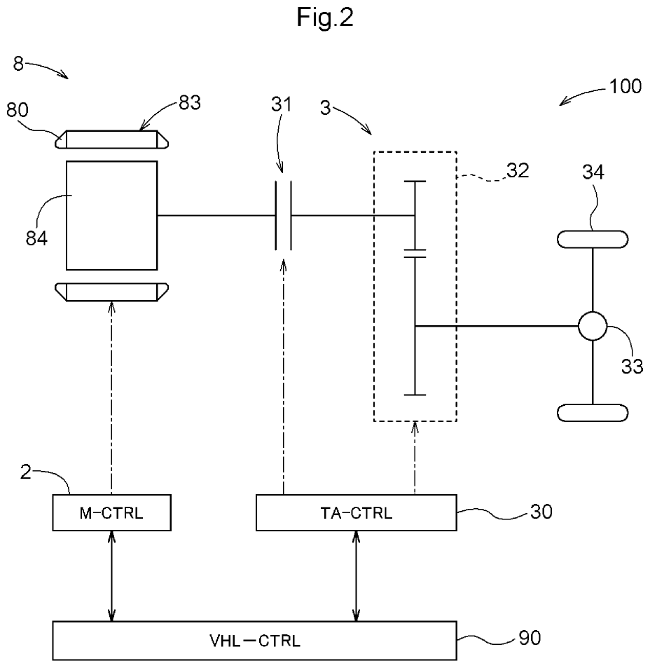

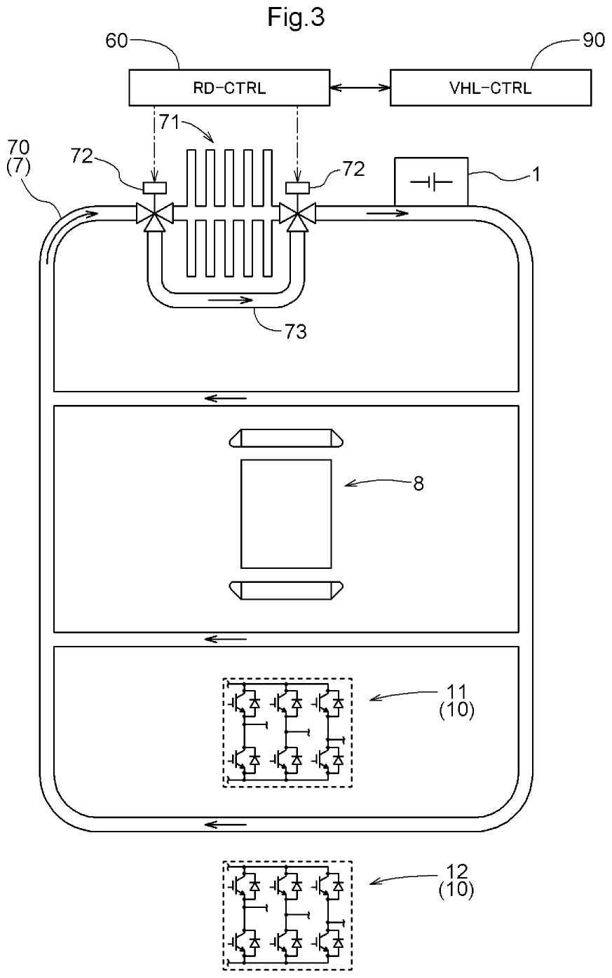

Hereinafter, an embodiment of a vehicle drive device will be described with reference to the drawings. FIG. 1 is a schematic diagram illustrating an electric system block that controls driving of a rotary electric machine 8. FIG. 2 is a train diagram illustrating an example of a power transmission path 3 connecting the rotary electric machine 8, serving as a drive power source for a vehicle, and wheels 34. FIG. 3 is a piping diagram illustrating an example of a refrigerant flow path 70 serving as a heat transfer system 7.

As illustrated in FIG. 1, a vehicle drive device 100 includes the rotary electric machine 8 that includes a plurality of mutually independent coil sets 80, each including coils of a plurality of phases connected to each other, and that serves as a drive power source for a vehicle. More specifically, the rotary electric machine 8 includes a single stator 83 and a single rotor 84, and the plurality of coil sets 80 are mounted on the single stator 83. The term “plurality of mutually independent coil sets 80” as used herein means that the coil sets 80 are not electrically connected to each other in the rotary electric machine 8 as illustrated in FIG. 1, and the coil sets 80 are respectively connected to different drive control circuits (inverters 10) so as to be independently subjected to drive control as described below. In this example, the coils of a plurality of phases are coils of three phases. However, the number of phases is not limited to three, and may be two or five. In this example, each coil set 80 is of the type in which coils of different phases are connected at a neutral point common to all the phases (a so-called Y type in the case of three phases). However, each coil set 80 may be of the type in which there is no neutral point and each coil is connected to the coils of two different phases (a so-called delta type in the case of three phases). In this example, the rotary electric machine 8 includes the two coil sets 80 (a first coil set 81 and a second coil set 82). However, the rotary electric machine 8 may include three or more coil sets 80. Note that the rotary electric machine 8 serves as an electric motor and an electric generator.

As illustrated in FIG. 2, the rotary electric machine 8 serving as a drive power source for a vehicle is drivingly coupled to wheels 34, via a clutch 31 (engagement device), a speed reducer 32, and a differential device 33, on the power transmission path 3 from the rotary electric machine 8 to the wheels 34. The stator 83 with the coil sets 80 mounted thereon is fixed to a case or other parts, and a rotary shaft of the rotor 84 is coupled to the clutch 31. The clutch 31 establishes the power transmission path 3 connecting the rotary electric machine 8 and the speed reducer 32 when engaged, and cuts off the power transmission path 3 when disengaged. More specifically, the power transmission path 3 is provided with an engagement device (clutch 31) that transmits power between the rotor 84 and the wheels 34 when in an engaged state, and cuts off power transmission between the rotor 84 and the wheels 34 when in a disengaged state. The speed reducer 32 is a transmission that reduces the rotational speed of the rotor 84 of the rotary electric machine 8. In this example, the speed reducer 32 is a fixed transmission having a fixed speed ratio. However, the speed reducer 32 may be a variable transmission that can vary the speed ratio. Note that in the case where a neutral stage for cutting off power transmission between an input stage and an output stage of the variable transmission is provided as a shift speed of the variable transmission, the clutch 31 does not have to be provided. In this case, a clutch and a brake provided in the variable transmission correspond to an engagement device that transmits power between the rotor 84 and the wheels 34 when in an engaged state, and cuts off power transmission between the rotor 84 and the wheels 34 when in a disengaged state. The differential device 33 distributes power to the two wheels 34 serving as driving wheels.

As illustrated in FIG. 2, the rotary electric machine 8 is controlled by a rotary electric machine control device 2 (M-CTRL). A transaxle including the clutch 31 and the speed reducer 32 (in the case of a variable transmission) is controlled by a transaxle control device 30 (TA-CTRL). The rotary electric machine control device 2 and the transaxle control device 30 respectively control the rotary electric machine 8 and the transaxle, based on a command from a vehicle control device 90 (VHL-CTRL) serving as a control device thereof.

As illustrated in FIG. 1, the electric system block that controls driving of a rotary electric machine includes an electronic control unit (ECU) 40 and the inverters 10. As described above, the rotary electric machine 8 includes the plurality of (two in this example) coil sets 80, and the plurality of (two in this example) inverters 10 corresponding to the respective coil sets 80. The plurality of inverters 10 (a first inverter 11 and a second inverter 12 in this example) independently control the currents flowing through the plurality of coil sets 80 (the first coil set 81 and the second coil set 82 in this example), respectively. In this example, the first inverter 11 controls the current flowing through the first coil set 81, and the second inverter 12 controls the current flowing through the second coil set 82.

In the present embodiment, a positive electrode power supply line and a negative electrode power supply line are shared by the plurality of inverters 10. At least one power storage device 1 is connected to the plurality of inverters 10. The power storage device 1 may be provided in plurality. In this case, at least one of the plurality of power storage devices 1 is connected to the inverters 10. Alternatively, in the case where the plurality of power storage devices 1 are provided, the plurality of inverters 10 may be respectively connected to the different power storage devices 1. A DC link capacitor 4 (smoothing capacitor) is connected to the DC side of the inverters 10 to smooth a DC voltage (DC link voltage). The DC link capacitor 4 is shared by the two inverters 10.

A contactor 9 capable of cutting off the positive electrode power supply line and the negative electrode power supply line is provided between the DC link capacitor 4 and the power storage device 1. The contactor 9 includes a relay (referred to as a system main relay, for example). Although not illustrated in FIG. 1, opening/closing of the relay is controlled by, for example, the vehicle control device 90 described above.

The power storage device 1 is a secondary battery such as a nickel hydride battery or a lithium-ion battery. The performance of the power storage device 1 tends to be reduced, such as a reduction in the amount of current that can be output, in a low temperature environment. Therefore, as will be described below, the vehicle drive device 100 is configured to be capable of heating the power storage device 1 in such a low temperature environment (warm-up control). As will be described in detail below, the vehicle drive device 100 causes the inverters 10 and the rotary electric machine 8 (the coil sets 80) to generate heat by driving the rotary electric machine 8, and heats the power storage device 1 using the generated heat. The heat generated by the inverters 10 and the rotary electric machine 8 (the coil sets 80) is transferred to the power storage device 1 via the heat transfer system 7 (see FIG. 3). The heat transfer system 7 transfers heat between the power storage device 1 and at least one of the rotary electric machine 8 and the plurality of inverters 10.

FIG. 3 is a piping diagram illustrating the refrigerant flow path 70 as an example of the heat transfer system 7. As illustrated in FIG. 3, the refrigerant flow path 70 is a flow path through which refrigerant circulates to cool the rotary electric machine 8, the first inverter 11, the second inverter 12, and the power storage device 1. In this example, the refrigerant flow path 70 is configured to pass through all of the rotary electric machine 8, the first inverter 11, and the second inverter 12. However, as long as the refrigerant flow path 70 passes through the power storage device 1, the refrigerant flow path may be configured to pass through only one of the rotary electric machine 8, the first inverter 11, and the second inverter 12. That is, the refrigerant flow path 70 only needs to be a flow path through which refrigerant circulates to cool at least one of the rotary electric machine 8 and the inverters 10, and the power storage device 1. In FIG. 3, the rotary electric machine 8, the first inverter 11, and the second inverter 12 are connected in parallel to the refrigerant flow path 70. However, these components may be connected in series.

A cooling device 71 that cools refrigerant is also connected to the refrigerant flow path 70. The cooling device 71 cools the refrigerant that has been heated by heat exchange with cooling target devices, that is, heat-generating devices (such as the rotary electric machine 8, the inverter 10, and the power storage device 1). Since the heated refrigerant has a reduced cooling effect, the cooling device 71 is preferably disposed at a position close to the downstream side of a device having a high heating value. The heating value of the power storage device 1 is generally less than those of the rotary electric machine 8 and the inverters 10. Therefore, as illustrated in FIG. 3, the cooling device 71 is preferably disposed at a position close to the downstream side of the rotary electric machine 8 and the inverters 10, and the upstream side of the power storage device 1.

In the case where the refrigerant cools the power storage device 1, it is preferable that the refrigerant having passed through the cooling device 71 is supplied to the power storage device 1. However, in the case of heating the power storage device 1 in a low temperature environment, it is not preferable that the refrigerant that has removed heat generated by the inverters 10 and the rotary electric machine 8 (coil sets 80) is cooled by the cooling device 71. Therefore, the refrigerant flow path 70 has a bypass flow path 73 that bypasses the cooling device 71. That is, the refrigerant flow path 70 is formed not to pass through the cooling device 71 that cools refrigerant, at least while the warm-up control (control for heating the power storage device 1 in a low temperature environment) is performed.

The refrigerant flow path 70 is provided with a flow switching valve 72, so that the refrigerant flow path 70 is configured to switch between a flow path for refrigerant to pass through the cooling device 71 and a flow path for refrigerant to pass through the bypass flow path 73 without passing through the cooling device 71. The flow switching valve 72 is controlled by a cooling system control device 60. The cooling system control device 60 controls the flow switching valve 72 in accordance with a command from the vehicle control device 90.

Each of the first inverter 11 and the second inverter 12 converts DC power having a DC link voltage to multi-phase (three-phase in this example) AC power to supply the AC power to the rotary electric machine 8, and also converts AC power generated by the rotary electric machine 8 to DC power to supply the DC power to the power storage device 1. Each of the first inverter 11 and the second inverter 12 includes a plurality of switching elements. Each switching element is preferably a power semiconductor element capable of operating at high frequency, such as an insulated gate bipolar transistor (IGBT), a power metal oxide semiconductor field effect transistor (MOSFET), a silicon carbide-metal oxide semiconductor FET (SiC-MOSFET), a SiC-static induction transistor (SiC-SIT), or a gallium nitride-MOSFET (GaN-MOSFET). In the example illustrated in FIG. 1, an IGBT is used as the switching element. Note that a free wheel diode is connected in parallel to each switching element, with the direction from the negative electrode to the positive electrode (the direction from the lower stage to the upper stage) as a forward direction.

As illustrated in FIG. 1, the inverters 10 (the first inverter 11 and the second inverter 12) are controlled by the rotary electric machine control device 2 (control device). The rotary electric machine control device 2 includes a logic circuit such as a microcomputer as a core member. For example, the rotary electric machine control device 2 performs current feedback control using a vector control method, based on a required torque for the rotary electric machine 8 provided from the vehicle control device 90, and thereby controls the rotary electric machine 8 via the inverters 10. The vector control method is well known, and will not be described in detail herein.

As described above, the first inverter 11 and the second inverter 12 independently control the currents flowing through the plurality of coil sets 80 (the first coil set 81 and the second coil set 82), respectively. Accordingly, the rotary electric machine control device 2 includes a first control unit 21 that controls the first inverter 11, a second control unit 22 that controls the second inverter 12, and an integrated control unit 20 that controls the first inverter 11 and the second inverter 12 together.

The integrated control unit 20 calculates currents to be applied to the respective first and second coil sets 81 and 82 (current commands for the respective first and second inverters 11 and 12), based on a required torque for the rotary electric machine 8 provided from the vehicle control device 90, and outputs the current commands to the first control unit 21 and the second control unit 22. The first control unit 21 and the second control unit 22 calculate voltage commands to be applied to the respective coil sets 80 (the first coil set 81 and the second coil set 82) by performing current feedback control, based on the deviations between the current commands and the currents flowing through the respective coil sets 80. As is well known, each inverter 10 performs switching of the switching elements of the inverter 10 through, for example, pulse width modulation, thereby converting DC power into AC power. The first control unit 21 and the second control unit 22 generate switching control signals, each having a pulse pattern for controlling switching of the corresponding inverter 10, based on these voltage commands.

The actual current flowing through the coil of each phase of the rotary electric machine 8 is detected by an AC current sensor 50, and the rotary electric machine control device 2 acquires the detection result. The AC current flowing through the first inverter 11 and the first coil set 81 is detected by a first AC current sensor 51. The AC current flowing through the second inverter 12 and the second coil set 82 is detected by a second AC current sensor 52. The magnetic pole position of the rotor 84 of the rotary electric machine 8 at each time point is detected by a rotation sensor 54 such as a resolver, and the rotary electric machine control device 2 acquires the detection result. The DC link voltage is detected by a DC voltage sensor 53, and the rotary electric machine control device 2 acquires the detection result.

As described above, the rotary electric machine control device 2 includes a logic circuit such as a microcomputer as a core member, and its operating voltage is about 3.3 [V] to 5 [V]. Meanwhile, the voltage of control signals (signals to be input to gate terminals and base terminals) for the power system switching elements such as IGBTs need to have a wave height of about 15 [V] to 20 [V]. Therefore, the switching control signals generated by the rotary electric machine control device 2 are provided to the inverters 10 via respective drive circuits that increase the driving capacity (the capacity for operating the circuits on the subsequent stage, such as the output voltage and the output current) of the control signals (switching control signals) for the respective switching elements.

As illustrated in FIG. 1, the switching control signal generated by the first control unit 21 is provided to the first inverter 11 via a first drive circuit 41 (DRV1). The switching control signal generated by the second control unit 22 is provided to the second inverter 12 via a second drive circuit 42 (DRV2). In this manner, the ECU 40 includes the rotary electric machine control device 2, and the drive circuits (the first drive circuit 41 and the second drive circuit 42).

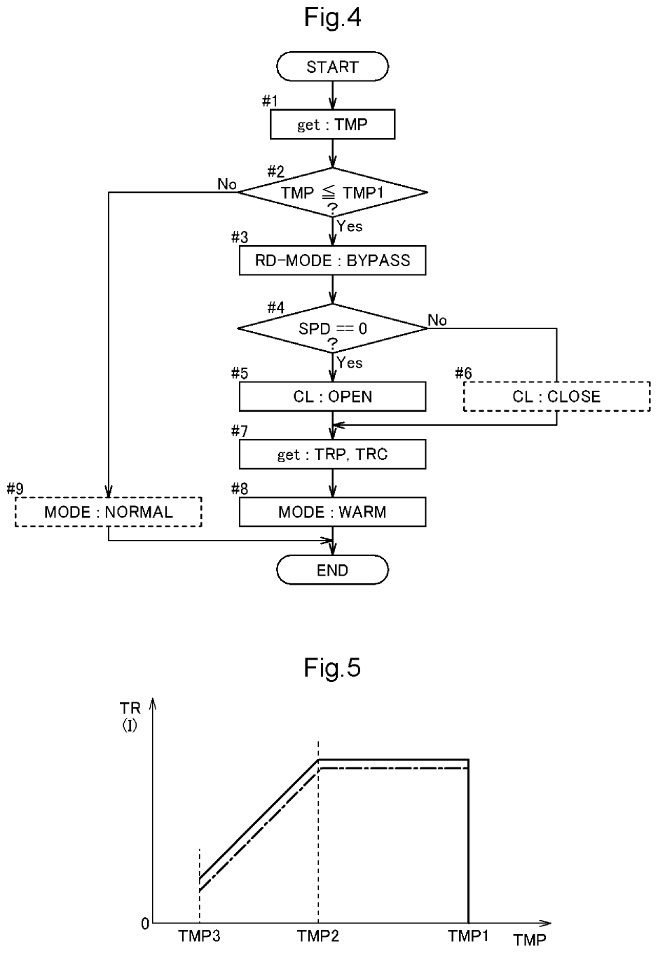

When the temperature of the power storage device 1 is less than or equal to a predetermined reference temperature (TMP1 described below), the rotary electric machine control device 2 performs warm-up control. In the following, a description will be given of warm-up control with reference to a flowchart of FIG. 4 and a torque map of FIG. 5. When performing warm-up control, the rotary electric machine control device 2 performs power running control on at least one of the plurality of inverters 10, and performs regenerative control on at least one of the other inverters 10. In this case, the rotary electric machine control device 2 performs warm-up control in such a manner that a power running torque resulting from the power running control and a regenerative torque resulting from the regenerative control have different absolute values so that the rotor 84 of the rotary electric machine 8 rotates.

With this warm-up control, a current is applied to the coil set 80 of the rotary electric machine 8 via the inverter 10 to cause the rotary electric machine 8 and the inverter 10 to generate heat, thereby heating the power storage device 1 via the heat transfer system 7. The coil sets 80 of the rotary electric machine 8 include one subjected to the power running control and one subjected to the regenerative control while the warm-up control is performed. Accordingly, the electric power consumed by the power running control, excluding the electric power consumed by heat generation of the coils, can be collected by the regenerative control. This makes it possible to reduce the electric power of the power storage device 1 consumed for heating the power storage device 1. Further, as illustrated in FIG. 1, the DC link capacitor 4 is connected to the DC side of the inverters 10, so that the electric power obtained by the regenerative control is charged to the DC link capacitor 4. Under the power running control, the electric power charged in the DC link capacitor 4 is preferentially used, which makes it possible to reduce the power consumption of the power storage device 1.

Note that under the warm-up control, the inverters 10 are controlled so that the rotor 84 of the rotary electric machine 8 rotates. Therefore, when the vehicle is stopped, the warm-up control is preferably performed in such a manner that the power transmission path 3 connecting the rotary electric machine 8 and the wheels 34 is cut off so as to prevent the wheels 34 from rotating with the rotation of the rotor 84. On the other hand, when the vehicle is in motion, it is not preferable that the torque of the rotor 84 resulting from the warm-up control inhibits the motion (including both the deceleration and acceleration) of the vehicle. Accordingly, when the vehicle is in motion, the warm-up control is preferably performed such that a required torque for the rotary electric machine 8 is output by the rotary electric machine 8.

As illustrated in FIG. 4, the rotary electric machine control device 2 (integrated control unit 20) acquires a temperature TMP of the power storage device 1 (#1), and determines whether the temperature TMP is less than or equal to a reference temperature TMP1 (#2). The temperature TMP of the power storage device 1 is detected by a temperature sensor (not illustrated). The temperature sensor is preferably a sensor that directly detects the temperature TMP of the power storage device 1. However, the temperature sensor is not limited thereto. The temperature sensor may be a sensor that detects a temperature affecting the temperature TMP of the power storage device 1, such as a sensor that detects a temperature around the power storage device 1 or a temperature around the vehicle, or a sensor that detects a temperature of refrigerant in the refrigerant flow path 70. Based on the determination result, the control mode (MODE) for the rotary electric machine 8 is set. If the temperature TMP is greater than the reference temperature TMP1, the control mode is not changed, and the rotary electric machine 8 is controlled in a normal control mode (NORMAL) (#9). On the other hand, if the temperature TMP is less than or equal to the reference temperature TMP1, preprocessing (#3 to #7) is performed, and then the rotary electric machine 8 is controlled in a warm-up control mode (WARM) (#8).

Note that the vehicle control device 90 may acquire the temperature TMP, determine whether the temperature TMP is less than or equal to the reference temperature TMP1, and transmit the determination result to the rotary electric machine control device 2. For example, if the temperature TMP is less than or equal to the reference temperature TMP1, the vehicle control device 90 may issue a warm-up control command to the rotary electric machine control device 2. The rotary electric machine control device 2 controls the rotary electric machine 8 in a warm-up control mode, based on the warm-up control command. On the other hand, if the temperature TMP is greater than the reference temperature TMP1, a warm-up control command is not issued. Therefore, the rotary electric machine control device 2 controls the rotary electric machine 8 in a usual control mode. Alternatively, the vehicle control device 90 may acquire the temperature TMP and transmit the temperature TMP to the rotary electric machine control device 2, and the rotary electric machine control device 2 having received the temperature TMP may determine whether the temperature TMP is less than or equal to the reference temperature TMP1.

If, in step #2, the temperature TMP of the power storage device 1 is determined to be less than or equal to the reference temperature TMP1, the rotary electric machine control device 2 controls the flow switching valve 72 via the cooling system control device 60 to switch from a cooling mode (RD-MODE) to a bypass mode (BYPASS) (#3). The rotary electric machine control device 2 may transmit a switching request directly to the cooling system control device 60, or may transmit a switching request to the cooling system control device 60 via the vehicle control device 90. In the case where the vehicle control device 90 determines whether the temperature TMP is less than or equal to the reference temperature TMP1, the vehicle control device 90 may issue a warm-up control command to the rotary electric machine control device 2, and issue a flow switching command to the cooling system control device 60.

If, in step #2, the temperature TMP of the power storage device 1 is determined to be less than or equal to the reference temperature TMP1, the rotary electric machine control device 2 determines whether the vehicle is stopped or in motion. For example, the rotary electric machine control device 2 determines whether the speed (SPD) of the vehicle is zero (#4). If the speed of the vehicle is zero, the vehicle is determined to be stopped. If the speed of the vehicle is not zero, the vehicle is determined to be in motion. Note that the speed of the vehicle is detected by, for example, a speed sensor (not illustrated) mounted on the wheel 34, or a rotation sensor (not illustrated) mounted on the speed reducer 32. The detection result is provided to the rotary electric machine control device 2 via, for example, the transaxle control device 30 and the vehicle control device 90 to the rotary electric machine control device 2. It is obvious that the rotary electric machine control device 2 may directly acquire the detection result.

If the speed of the vehicle is zero, the rotary electric machine control device 2 controls the engagement mode (CL) of the clutch 31 to an open state (OPEN) via the transaxle control device 30 to cut off the power transmission path 3 connecting the rotary electric machine 8 and the wheels 34 (#5). On the other hand, if the speed of the vehicle is not zero, the vehicle is in motion, and therefore the engagement mode (CL) of the clutch 31 is maintained in an engaged state (CLOSE) (#6).

In the case where the vehicle control device 90 acquires the temperature TMP and determines whether the temperature TMP is less than or equal to the reference temperature TMP1 as described above, the vehicle control device 90 may further determine whether the vehicle is stopped or in motion. For example, if the temperature TMP is less than or equal to the reference temperature TMP1, the vehicle control device 90 issues a warm-up control command to the rotary electric machine control device 2, and issues a flow switching command to the cooling system control device 60. Further, if the speed of the vehicle is zero, the vehicle control device 90 issues, to the transaxle control device 30, an open command for setting the engagement mode of the clutch 31 to the open state.

Note that step #3 and steps #4 and #5 (or #6) may be performed in the reverse order. The operations in these steps are so-called preprocessing to be performed before the rotary electric machine control device 2 controls the rotary electric machine 8 in an electric machine control mode (WARM). Accordingly, step #3 and steps #4 and #5 (or #6) only need to be performed before the rotary electric machine 8 is controlled in the warm-up control mode.

When preprocessing is completed, the rotary electric machine control device 2 performs warm-up control based on the power running torque and the regenerative torque. More specifically, the rotary electric machine control device 2 performs warm-up control by performing power running control on at least one of the plurality of inverters 10 (in this example, either one of the first inverter 11 and the second inverter 12) and performing regenerative control on at least one of the other inverters (in this example, the other one of the first inverter 11 and the second inverter 12) in such a manner that a power running torque TRP and a regenerative torque TRC have different absolute values so that the rotor 84 of the rotary electric machine 8 rotates.

As will be described below, the rotary electric machine control device 2 can variably set the power running torque TRP and the regenerative torque TRC in accordance with the temperature TMP of the power storage device 1. For example, the power running torque TRP and the regenerative torque TRC are stored as a torque map in a memory or a register of the rotary electric machine control device 2 (the characteristics of the torque map will be described below with reference to FIG. 5). The rotary electric machine control device 2 acquires the power running torque TRP and the regenerative torque TRC, based on the temperature TMP of the power storage device 1 (#7). Then, the rotary electric machine control device 2 performs warm-up control on the rotary electric machine 8, based on the power running torque TRP and the regenerative torque TRC (#8).

The performance of the power storage device 1 tends to decrease as its temperature TMP decreases. One way to address this issue may be, for example, to increase the power running torque TRP or the regenerative torque TRC as the temperature decreases, thereby applying a greater amount of current to the coil set 80 so as to generate heat. However, in the case where the temperature TMP is extremely low, the power storage device 1 may be further drained by the warm-up control. Accordingly, a determination of whether to perform warm-up control and to what extent heat is applied is preferably made taking into account the necessity of warm-up, the allowable energy (current) for warm-up, and so on.

The graph of FIG. 5 represents the relationship between the temperature TMP of the power storage device 1 and each of the absolute value of the power running torque TRP and the absolute value of the regenerative torque TRC. A torque map is created based on this graph, for example. As described above, the warm-up control is performed in such a manner that the power running torque TRP and the regenerative torque TRC have different absolute values to cause the rotor 84 to rotate. For example, the solid line in FIG. 5 indicates one of the absolute value of the power running torque TRP and the absolute value of the regenerative torque TRC, and the dotted and dashed line indicates the other one of the absolute value of the power running torque TRP and the absolute value of the regenerative torque TRC.

The warm-up control is performed when the temperature TMP of the power storage device 1 is less than or equal to the reference temperature TMP1. Therefore, when the temperature TMP of the power storage device 1 is greater than the reference temperature TMP1, the absolute value of the power running torque TRP and the absolute value of the regenerative torque TRC are zero. In the present embodiment, when the temperature TMP is between the reference temperature TMP1 and a limit temperature TMP2 that is less than the reference temperature TMP1, each of the absolute value of the power running torque TRP and the absolute value of the regenerative torque TRC is set to a constant value. Note that, unlike the example illustrated in FIG. 5, when the temperature TMP is between the reference temperature TMP1 and the limit temperature TMP2, the absolute value of the power running torque TRP and the absolute value of the regenerative torque TRC may be set to increase as the temperature TMP decreases from the reference temperature TMP1.

The limit temperature TMP2 is a threshold temperature at which the warm-up control is prohibited. That is, when the temperature TMP of the power storage device 1 is less than or equal to the limit temperature TMP2, the power storage device 1 may be drained by the warm-up control, and therefore the warm-up control is prohibited. More specifically, the absolute value of the power running torque TRP and the absolute value of the regenerative torque TRC are set to decrease as the temperature TMP decreases from the limit temperature TMP2. Then, when the temperature TMP of the power storage device 1 falls to or below a warm-up prohibition temperature TMP3 that is less than the limit temperature TMP2, the warm-up control is prohibited. Accordingly, when the temperature TMP of the power storage device 1 is less than or equal to the warm-up prohibition temperature TMP3, the absolute value of the power running torque TRP and the absolute value of the regenerative torque TRC are set to zero.

As described above, with this vehicle drive device 100, it is possible to appropriately heat the power storage device 1 in a low temperature environment, while preventing the device configuration from becoming complicated, and minimizing a reduction in electric power utilization efficiency of the power storage device 1.

### OTHER EMBODIMENTS

Hereinafter, other embodiments will be described. The configuration disclosed in each of the following embodiments may be applied alone, or may be applied in combination with the configuration disclosed in any other embodiments as long as no inconsistency arises.

(1) In the above description, when the vehicle is stopped, the warm-up control is performed in such a manner that the power transmission path 3 connecting the rotary electric machine 8 and the wheels 34 is cut off. When the vehicle is in motion, the warm-up control is performed in such a manner that the required torque for the rotary electric machine 8 is output by the rotary electric machine 8. However, the present disclosure is not limited thereto as long as the influence of the torque variation due to the warm-up control on the vehicle behavior while the vehicle is stopped and the vehicle behavior while the vehicle is in motion is within an allowable range.

(2) In the above description, the refrigerant flow path 70 through which refrigerant circulates is illustrated as the heat transfer system 7. However, the heat transfer system 7 may be a solid made of metal or other materials.

(3) In the above description, the power running torque TRP and the regenerative torque TRC are set to vary with the temperature TMP of the power storage device 1. However, the power running torque TRP and the regenerative torque TRC may be constant regardless of the temperature TMP of the power storage device 1. For example, each of the power running torque TRP and the regenerative torque TRC may be set to a constant value when the temperature TMP of the power storage device 1 is greater than the warm-up prohibition temperature TMP3 and less than or equal to the reference temperature TMP1, and set to zero when the temperature TMP is greater than the reference temperature TMP1 and less than or equal to the warm-up prohibition temperature TMP3.

(4) In the above description, the rotary electric machine control device 2 performs warm-up control when the temperature TMP of the power storage device 1 is less than or equal to the reference temperature TMP1. However, the warm-up control may be performed every time the vehicle is started regardless of the temperature TMP of the power storage device 1.

### Summary of Embodiment

The following provides a brief summary of the vehicle drive device (1) described above.

According to an aspect, the vehicle drive device (100) includes: a rotary electric machine (8) that includes a plurality of mutually independent coil sets (80), each including coils of a plurality of phases connected to each other, and that serves as a drive power source for a vehicle; a plurality of inverters (10) that independently control currents flowing through the respective plurality of coil sets (80); at least one power storage device (1) connected to the plurality of inverters (10); a heat transfer system (7) that transfers heat between the power storage device (1) and at least one of the rotary electric machine (8) and the plurality of inverters (10); and a control device (2) that controls the plurality of inverters (10) to control the rotary electric machine (8); wherein the control device (2) performs warm-up control by performing power running control on at least one of the plurality of inverters (10) and performing regenerative control on at least another of the inverters (10) in such a manner that a power running torque (TRP) resulting from the power running control and a regenerative torque (TRC) resulting from the regenerative control have different absolute values so that a rotor (84) of the rotary electric machine (8) rotates.

According to this configuration, with the warm-up control, a current is applied to the coil set (80) of the rotary electric machine (8) via the inverter (10) to cause the rotary electric machine (8) and the inverter (10) to generate heat. The generated heat is transferred to the power storage device (1) via a heat transfer system (7), thereby heating the power storage device (1). Therefore, there is no need to separately provide a heater or other devices for heating the power storage device (1), thereby preventing the device structure from becoming complicated. Meanwhile, at least one of the coil sets (80) of the rotary electric machine (8) is subjected to the power running control, and at least one of the other coil sets (80) is subjected to the regenerative control, while the warm-up control is performed. Accordingly, the electric power consumed by the power running control, excluding the electric power consumed by heat generation of the coils, can be collected by the regenerative control. This makes it possible to reduce the electric power of the power storage device (1) consumed for heating the power storage device (1). Thus, with this configuration, it is possible to appropriately heat the power storage device in a low temperature environment, while preventing the device configuration from becoming complicated, and minimizing a reduction in electric power utilization efficiency.

Further, it is preferable that the control device (2) perform the warm-up control when a temperature (TMP) of the power storage device (1) is less than or equal to a predetermined reference temperature (TMP1).

When the temperature (TMP) of the power storage device (1) is equal to or less than the reference temperature (TMP1), the necessity for heating the power storage device (1) is relatively high. When the temperature (TMP) of the power storage device (1) is greater than the reference temperature (TMP1), the necessity for heating the power storage device (1) is low. Although the warm-up control may be performed, for example, every time the vehicle is started, the warm-up control according to the above configuration is performed when the necessity for heating the power storage device (1) is relatively high, and is not performed when the necessity for heating the power storage device (1) is low. It is therefore possible to reduce the occurrence of loss due to the warm-up control.

Further, when the vehicle is stopped, it is preferable that the warm-up control be performed in such a manner that a power transmission path (3) connecting the rotary electric machine (8) and wheels (34) is cut off.

Under the warm-up control, the rotor (84) of the rotary electric machine (8) is controlled to rotate. Therefore, when the vehicle is stopped, the warm-up control is preferably performed in such a manner that the power transmission path (3) is cut off so as to prevent the wheels (34) from rotating with the rotation of the rotor (84).

More specifically, it is preferable that the power transmission path (3) be configured to drivingly couple the rotor (84) and the wheels (34), and the power transmission path (3) be provided with an engagement device (31) that transmits power between the rotor (84) and the wheels (34) when in an engaged state, and cut off power transmission between the rotor (84) and the wheels (34) when in a disengaged state.

With this configuration, when the vehicle is in motion, power is appropriately transmitted between the rotor (84) and the wheels (34) by the engagement device (31). When, for example, the warm-up control is performed while the vehicle is stopped, power transmission between the rotor (84) and the wheels (34) is cut off so as to prevent the wheels (34) from rotating with the rotation of the rotor (84).

Further, it is preferable that when the vehicle is in motion, the warm-up control be performed such that a required torque for the rotary electric machine (8) is output by the rotary electric machine (8).

When the vehicle is in motion, it is not preferable that the torque of the rotor (84) resulting from the warm-up control inhibit the motion (including both the deceleration and acceleration) of the vehicle. Therefore, when the vehicle is in motion, the warm-up control is preferably performed such that a required torque for the rotary electric machine (8) is output by the rotary electric machine (8).

Further, it is preferable that the heat transfer system (7) be a refrigerant flow path (70) through which refrigerant circulates to cool at least one of the rotary electric machine (8) and the inverters (10), and the power storage device (1), and the refrigerant flow path (70) from at least one of the rotary electric machine (8) and the inverters (10) to the power storage device (1) be formed not to pass through a cooling device (71) that cools the refrigerant, at least while the warm-up control is performed.

Generally, the rotary electric machine (8), the inverters (10), and the power storage device (1) are connected to the refrigerant flow path (70) through which refrigerant circulates to cool these components when heat is generated. Therefore, in the case of heating the power storage device (1), the refrigerant flow path (70) is preferably used as the heat transfer system (7) to eliminate the need for separately providing a heat transfer system (7). However, in some cases, the refrigerant having exchanged heat with the rotary electric machine (8) and the inverter (10) that tend to generate a greater amount of heat than the power storage device (1) is cooled by the cooling device (71), and then is used for cooling the power storage device (1). When the warm-up control is performed, it is not preferable that the cooled refrigerant is supplied to the power storage device (1). With the above configuration, since the refrigerant flow path (70) to the power storage device (1) is configured not to pass through the cooling device (71) at least while the warm-up control is performed, the power storage device (1) is appropriately heated.

Further, it is preferable that the rotary electric machine control device (2) variably set the power running torque (TRP) and the regenerative torque (TRC) in accordance with a temperature (TMP) of the power storage device (1).

The performance of the power storage device (1) tends to decrease as its temperature (TMP) decreases. One way to address with this issue is, for example, to increase the power running torque (TRP) or the regenerative torque (TRC) as the temperature (TMP) decreases, thereby applying a great amount of current to the coil set (80) so as to generate heat. However, in the case where the temperature (TMP) is extremely low, the power storage device (1) may be further drained by the warm-up control. Accordingly, a determination of whether to perform warm-up control and to what extent heat is applied is preferably made taking into account the necessity of warm-up, the allowable energy (current) for warm-up, and so on. With the above configuration, the power running torque (TRP) and the regenerative torque (TRC) are variably set in accordance with the temperature (TMP) of the power storage device (1), thereby making it possible to appropriately perform the warm-up control.

### DESCRIPTION OF THE REFERENCE NUMERALS

1 power storage device
2 rotary electric machine control device (control device)
3 power transmission path
7 heat transfer system
8 rotary electric machine
10 inverter
31 clutch (engagement device)
34 wheel
70 refrigerant flow path
71 cooling device
80 coil set
84 rotor
100 vehicle drive device
TMP temperature
TMP1 reference temperature
TRC regenerative torque
TRP power running torque

1. A vehicle drive device comprising:
a rotary electric machine that includes a plurality of mutually independent coil sets, each including coils of a plurality of phases connected to each other, and that serves as a drive power source for a vehicle;
a plurality of inverters that independently control currents flowing through the respective plurality of coil sets;
at least one power storage device connected to the plurality of inverters;
a heat transfer system that transfers heat between the power storage device and at least one of the rotary electric machine and the plurality of inverters; and
a control device that controls the plurality of inverters to control the rotary electric machine, wherein
the control device performs warm-up control by performing power running control on at least one of the plurality of inverters and performing regenerative control on at least another of the inverters in such a manner that a power running torque resulting from the power running control and a regenerative torque resulting from the regenerative control have different absolute values so that a rotor of the rotary electric machine rotates.

2. The vehicle drive device according to claim 1, wherein the control device performs the warm-up control when a temperature of the power storage device is less than or equal to a predetermined reference temperature.

3. The vehicle drive device according to claim 1, wherein when the vehicle is stopped, the warm-up control is performed in such a manner that a power transmission path connecting the rotary electric machine and wheels is cut off.

4. The vehicle drive device according to claim 3, wherein the power transmission path is configured to drivingly couple the rotor and the wheels, and the power transmission path is provided with an engagement device that transmits power between the rotor and the wheels when in an engaged state, and cuts off power transmission between the rotor and the wheels when in a disengaged state.

5. The vehicle drive device according to claim 1, wherein when the vehicle is in motion, the warm-up control is performed such that a required torque for the rotary electric machine is output by the rotary electric machine.

6. The vehicle drive device according to claim 1, wherein the heat transfer system is a refrigerant flow path through which refrigerant circulates to cool at least one of the rotary electric machine and the inverters, and the power storage device, and the refrigerant flow path from at least one of the rotary electric machine and the inverters to the power storage device is formed not to pass through a cooling device that cools the refrigerant, at least while the warm-up control is performed.

7. The vehicle drive device according to claim 1, wherein the control device variably sets the power running torque and the regenerative torque in accordance with a temperature of the power storage device.
